(19) United States
(12) Patent Application Publication
(10) Pub. No.: US 2005/0097483 A1
(43) Pub. Date: May 5, 2005

(54) Verifier and method for unknown spacing rule checking

(76) Inventors: Hsin-Pang Lu, Hsin-Chu City (TW); Chung-Hao Cheng, Chung-Li City (TW)

Correspondence Address: LOWE HAUPTMAN GILMAN & BERNER, LLP, Suite 310, 1700 Diagonal Road, Alexandria, VA, 22314, US

(21) Appl. No.: 10/700,459

(22) Filed: Nov. 5, 2003

(51) Int. Cl. G06F 9/45

(52) U.S. Cl. 716/5

(57) ABSTRACT

Disclosed are a verifier and method for dimension rule check. By checking all basic units in a database and the basic units related to the bulk according to predefined spacing rules, a warning set within the database can be distinguished from those basic units checked by spacing rules. The warning set can specify where or what may be ignored by the spacing rules and should be concerned to refine the spacing rules.

### BACKGROUND OF THE PRESENT INVENTION

1. Field of the Invention

The invention relates to a manufacturing processes, and more particularly, to a Design Rule Checking in a manufacturing.

2. Description of the Prior Art

U.S. Pat. No. 5,483,603 of Luke et al. for “System and Method for Automatic Optical Inspection” shows a method for automatic optical inspection.

U.S. Pat. No. 5,590,049 assigned to Cadence Design Systems of Arora for “Method and System for User Programmable Design Verification for Printed Circuit Boards and Multichip Modules” shows a method for design verification.

U.S. Pat. No. 5,754,826 of Gamal et al for “CAD and Simulation System for Targeting IC Designs to Multiple Fabrication Processes” describes Design Review Check (DRC) using Dracula (TM) from Cadence starting with a GDSII file (a polygon level description). Errors are reported.

U.S. Pat. No. 5,764,793 of Omae et al. for “Method of and Apparatus for Inspecting Pattern Defects” describes a design rule check circuit for “DRC” inspection which uses a compare check method relative to a reference pattern image.

U.S. Pat. No. 5,781,446 of Wu for “System and Method for Multi-Constraint Domain Electronic System Design Mapping” describes at Col. 2, lines 29-39, a physical spacing DRC performed to verify that adequate spacing exists between adjacent components to accommodate conductor routing channels or the handling head of a pick-and-place PCB manufacturing system.

U.S. Pat. No. 5,787,006 of Chevallier et al. for “Apparatus and Method for Management of Integrated Circuit Layout Verification Processes” describes DRC and Layout Versus Schematic (LVS) verification procedures, in considerable detail.

DRC software applications have been around for many years, and are not only stable and robust, but also very similar. Most DRC software has the capability of generating shapes according to user specified rules. This capability is used to support the verification of layout design rules. In DRC applications such shapes are used as an intermediate step and are not intended to be printed or merged with the design database.

For examples, DRC can be applied for Lithographic Proximity Corrections (LPC) to very large scale integrated (VLSI) circuit design databases to compensate for 2-dimensional (2-D) lithographic errors. LPC attempts to overcome a shortcoming in lithography that prevents the accurate printing of shapes in a design database when the minimum dimensions of the shapes are approximately the same as or below the wavelength of exposure. 2-D lithographic proximity effects occur in mask manufacture, because of electromagnetic diffraction from orthogonal edges of a mask feature, and 2-D chemical effects in the photoresist. The results are generally undesirable. The effects can be overcome by modifying the shapes from their original design in ways that take place during printing. Thus, even though a corrected mask doesn't resemble an intended design, when the corrected mask is finally printed on a wafer, the wafer pattern better matches the intended design.

Up to the present, algorithm of spacing check in dimension rule checking is just checking space rules wrote by user. If some spacing rule user has not specified, the algorithm would not show any warning messages to user. It would be very serious because it would cause chip failed as some spacing rule violation user doesn't know.

FIG. 1A is an example of DRC of the prior art. Polygons A, B and C are elements of a database. They are included in bulk edges in the database. Rule 1 and rule 2 have been defined and checked, but there is still somewhere needed to be concerned by some undefined rules. Referring to FIG. 1B, all polygon edges are formed in step 110. Then the DRC of the prior art is performed in the step 130, all polygon edges are checked by DRC. The results of DRC will include the violated edges and inviolate edges. Then, step 160 output the results. From older algorithm, DRC just check spacing rules users have written. Unless all possible rules are considered, it would occur some space rule has not check but still tape out. Serious chip failure would be caused.

Accordingly, a completely user defined spacing rules set is too hard to approach at once. It needs well-experienced skills and a lot of efforts to check out. Thus, an improved DRC verifier for helping to complete the user defined spacing rules is desired.

### SUMMARY OF THE PRESENT INVENTION

One main purpose of the present invention is to provide a method for dimension rule checking.

Another main purpose of the present invention is to provide a verifier for warning the disregard checking in a database.

According to the purposes described above, the present invention provides a verifier and a method for dimension rule check. By checking all basic units in a database and the basic units related to the bulk according to predefined spacing rules, a warning set within the database can be distinguished from those basic units checked by spacing rules. The warning set can specify where or what may be ignored by the spacing rules and should be concerned to refine the spacing rules.

### BRIEF DESCRIPTION OF THE DRAWINGS

A better understanding of the present invention can be obtained when the following Detailed Description is considered in conjunction with the following drawings, in which:

FIG. 1A and FIG. 1B is the diagrams of the prior art;

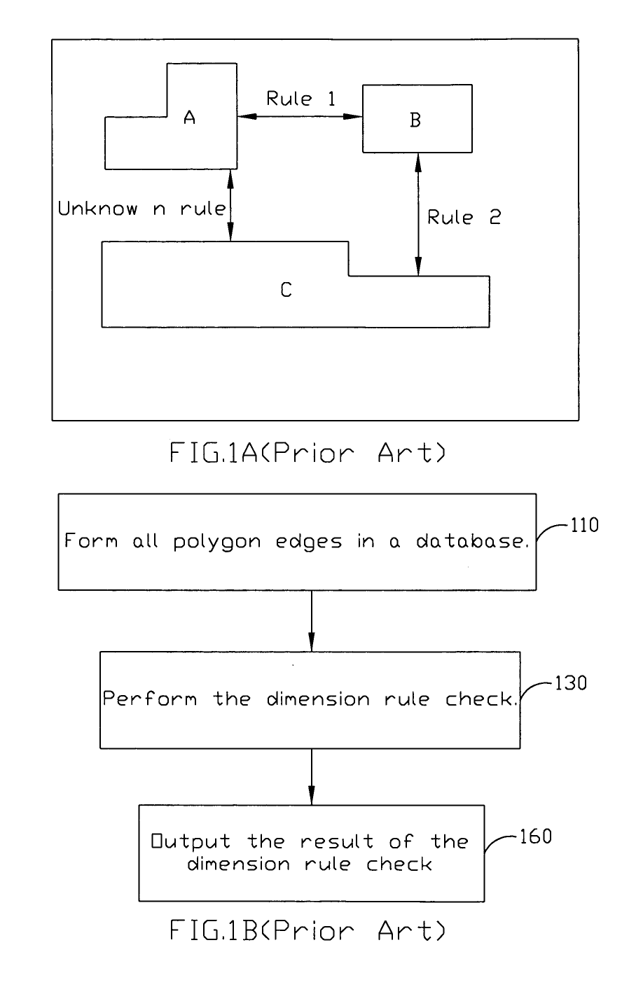

FIG. 2A and FIG. 2B are the function block diagrams of one embodiment of the present invention; and

FIG. 3A and FIG. 3B are the diagrams of another embodiment of the present invention.

### DETAIL DESCRIPTION OF THE PREFERRED EMBODIMENT

A method of reviewing a Design Rule Check (DRC) for every new coming product is very important in contemporary fabrication plants. However with in currently available review methods for use with the DRC, one needs to completely define all possible rules at once. This is almost impossible to complete for any chips which is designed by current chip design methodology.

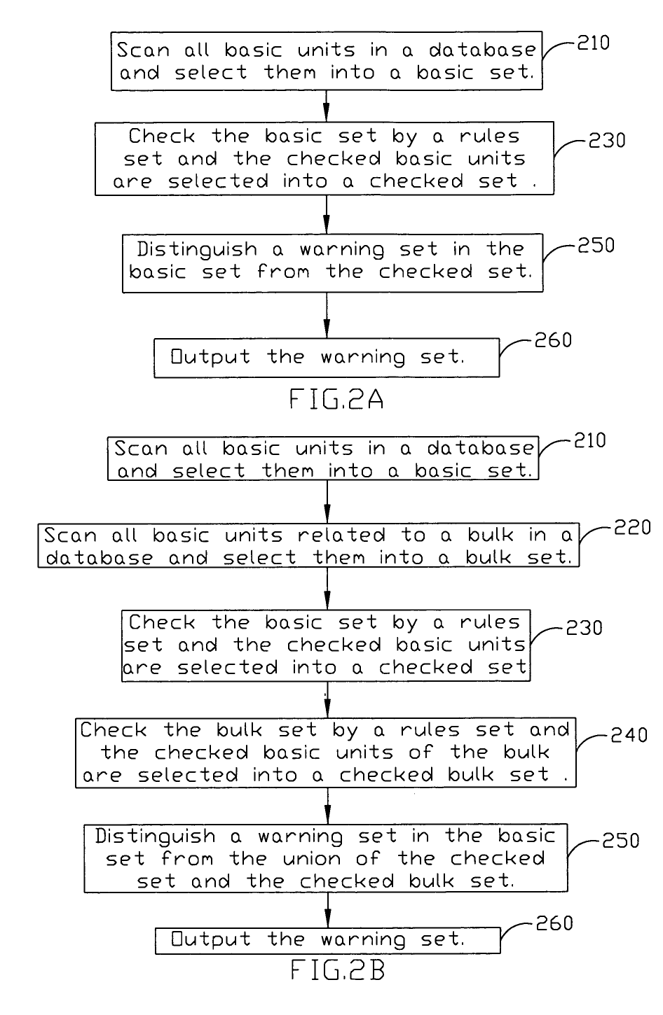

This invention provides a way to prompt somewhere not being concerned by the current spacing rules written by users. FIG. 2A is a method for dimension rule checking of one preferred embodiment of the present invention. Firstly, step 210 scans all basic units in a database, wherein all scanned basic units in the database are comprised in a basic set. The database includes all elements of a layout and the basic units could be line segments, edges, polygons, circles, modules and so on.

Then checking rules of a rules set is used to check the database in step 230, and all basic units checked by said rules set are comprised in a checked set. The rules can be some spacing rules that verify the geometric relations between the checked targets and their neighbors. These checked basic units could be departed violated ones from inviolate ones according to said rules set. No matter how many rules violated by a basic unit, it will be categorized violated. Obviously, some unchecked basic units could be left behind.

Next, step 250 distinguishes a warning set in said basic set from checked set. Comparing said basic set and checked set could separate out the warning set obviously. That is, the warning set comprises those unchecked basic units, which are left behind by the rules set. And finally, the warning set is outputted by step 260. The warning set could be transform in any forms to specify what or where should be concerned more.

The preferred embodiment can further check the bulk. The bulk can be included in the database and surrounds the layout of the main elements. Thus the bulk should not be left behind by the rules set either, if we wish not to impute something to the bulk. Referring to FIG. 2B, the method for dimension rule check further comprises step 220 for scanning all basic units related to the bulk in the database, wherein all scanned basic units related to the bulk are comprised in a bulk set. The bulk set can be a subset of the checked set or stand-alone. For example, the bulk set can be those basic units directly face to the bulk or the edges of the bulk. The order of step 220, step 210 and step 230 can be varied.

After step 220, Step 240 checks the bulk by the rules set, and all basic units related to the bulk checked by the rules set are comprised in a checked bulk set. The checked bulk set can be derived by checking the bulk set or the basic set, if the bulk set is included in basic set. It means that the bulk set can be included in the checked set, if the bulk set is included in the basic set. Besides the order of step 210, 220, 230 and 240 can be varied. For example, the order can be 210, 230, 200, 240 or 230, 200, 210, 240. The order in the present invention is not limited.

Moreover, the step 250 can further distinguishing the warning set in the union of the checked set and the checked bulk set. That is, the basic units that are also comprised in the checked bulk set are further excluded from said warning set in verifying the checking. Then the rules set can be further refined according to the warning set, and the DRC will be better and better.

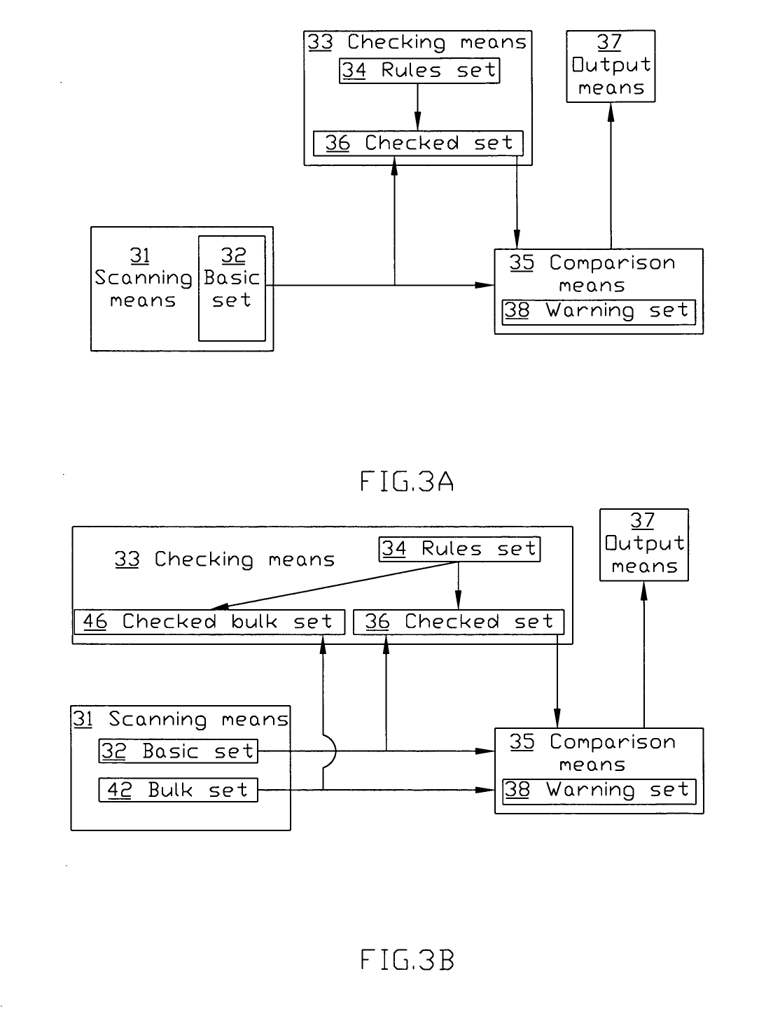

Accordingly, another preferred embodiment of the present invention is a verifier for dimension rule checking. Referring to FIG. 3A, the verifier for dimension rule checking includes a rules set 34, a scanning means 31, a checking means 33, a comparison means 35 and an output means 37. The scanning means 31 introduces a basic set 32 by scanning all basic units in the database according to step 210. Then the checking means 33, depending on the step 230, checks the basic set 32 to introduce the checked set 36 according the rules set 34. Afterwards, comparison means 35 distinguishes a warning set 38 in the basic set 32 from the checked set 36 according step 350. Finally, the output means 37 outputs the warning set 38 according to step 360.

Also, if the basic set 32 does not includes the basic units related to the bulk, the scanning means 31 can further comprises scanning the basic units related to the bulk and collecting them into a bulk set 42 according to step 220. Besides, the checking means 33 further comprises checking the bulk by the rules set 34 to collect all checked basic units in the bulk set into a checked bulk set 46 according to step 240. Then the comparison means 35 further excludes the checked bulk 46 set from the warning set 38.

What are described above are only preferred embodiments of the invention, not for confining the claims of the invention; and for those who are familiar with the present technical field, the description above can be understood and put into practice, therefore any equal-effect variations or modifications made within the spirit disclosed by the invention should be included in the appended claims.

1. A method for dimension rule checking, comprising:
scanning all basic units in a database, wherein all the scanned basic units in said database are included in a basic set;
checking said basic set according to said rules set, wherein all the checked basic units in said basic set are included in a checked set;
distinguishing a warning set in said basic set from said checked set; and
outputting said warning set.

2. The method according to claim 1, wherein said basic unit is a line segment.

3. The method according to claim 1, wherein said basic unit is an edge of a polygon.

4. The method according to claim 1, wherein said rules set comprises a plurality of spacing checking rules, and said checked set comprises said basic units that are violated and inviolate according to said rules set.

5. The method according to claim 1, further comprising scanning all basic units related to a bulk in said database, wherein all scanned basic units related to said bulk are comprised in a bulk set.

6. The method according to claim 6, wherein said checked basic units in said bulk set are directly faced said bulk.

7. The method according to claim 6, wherein said checked basic units in said bulk set are the edges of said bulk.

8. The method according to claim 5, further comprising checking said bulk by said rules set, wherein all checked basic units in said bulk set are comprised in a checked bulk set.

9. The method according to claim 6, wherein said basic units that are also comprised in said checked bulk set are further excluded from said warning set.

10. The method according to claim 6, further comprising refining said rules set before outputting said warning set, wherein said rules set is refined according to said warning set.

11. A verifier for dimension rule checking, comprising:
a rules set for dimension rule checking;
scanning means for scanning all basic units in a database, wherein all the scanned basic units in said database are included in a basic set;
checking means for checking said basic units according to said rules set, wherein all the checked basic units are included in a checked set;
comparison means for distinguishing a warning set in said basic set from checked set; and
output means for outputting said warning set.

12. The verifier according to claim 10, wherein said basic unit is a line segment.

13. The verifier according to claim 10, wherein said basic unit is an edge of a polygon.

14. The verifier according to claim 10, wherein said rules set comprises a plurality of spacing checking rules, and said checked set comprises said basic units that are violated and inviolate according to said rules set.

15. The verifier according to claim 10, wherein said scanning means further comprises scanning all basic units related to a bulk in said database, wherein all scanned basic units related to said bulk are comprised in an bulk set.

16. The verifier according to claim 15, wherein said checked basic units in said bulk set are directly faced said bulk.

17. The verifier according to claim 15, wherein said checked basic units in said bulk set are the edges of said bulk.

18. The verifier according to claim 15, wherein said checking means further comprises checking said bulk by said rules set, wherein all checked basic units in said bulk set are comprised in a checked bulk set.

19. The verifier according to claim 16, wherein said basic units that are also comprised in said checked bulk set are further excluded from said warning set.

20. The verifier according to claim 16, further comprise refining said rules set before outputting said warning set, wherein said rules set is refined according to said warning set.
